(19) United States
(12) Patent Application Publication
(10) Pub. No.: US 2002/0073113 A1
(43) Pub. Date: Jun. 13, 2002

(54) Computer-implemented collaborative record-keeping system and method

(76) Inventors: William Frederick Caraher JR., Wilmington, DE (US); Robert Alan Elkins, Bear, DE (US); James Edward Hornshuh, Newark, DE (US); Kewal Krishan Likhyani, Hockessin, DE (US); Roger Allen Patterson, Wilmington, DE (US); Rajeevi Subramanian, Kennett Square, PA (US); Larry James Van Stone, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 09/975,894

(22) Filed: Oct. 12, 2001

Related U.S. Application Data
(60) Provisional application No. 60/240,132, filed on Oct. 13, 2000.

(51) Int. Cl. G06F 7/00

(52) U.S. Cl. 707/500

(57) ABSTRACT

A computer-implemented system and method for collaborative record-keeping is characterized by an author signature string that is derived from a hashed combination of at least a portion of the record, a first date/time stamp provided by a server, and a data string representative of the identity of the author. A witness signature string derived from a hashed combination of a second date/time stamp provided by the server and a data string representative of the identity of the witness is also appended to the record. The signed and witnessed electronic record is stored in a write-protected and delete-protected manner.

### CROSS-REFERENCE TO RELATED APPLICATIONS

This application claims the benefit of priority to provisional application 60/240,132 filed Oct. 13, 2000.

### BACKGROUND OF THE INVENTION

1. Field of the Invention

This invention relates to a computer-implemented system and method for collaborative record-keeping that includes a server node and at least one, but more preferably, a plurality of user nodes which may be utilized by either an author for creating a record or by a witness for witnessing a record.

2. Description of the Prior Art

In the industrial research context, a “paper notebook” is a bound collection of pre-numbered pages, issued by a custodial authority that temporarily assigns physical control of a notebook to an author. The basic functions supported by a paper notebook are:

the entry of data, either by writing upon the page or by affixing printed material;

the entry of text written by the notebook author, such as experimental design notes or conclusions, either by writing upon the page or by affixing printed material;

the affixing to the page of graphical or pictorial material such as the output of plotters or printers;

the writing of the author's signature and the date of signing, so the page is “signed”;

the writing of a witness' signature and the date of the witness' signing, so the page is “signed and witnessed”;

the reading or perusal by any person to whom the author chooses to allow temporary possession of the notebook, or by any person so allowed by a custodial authority which attains physical custody of the notebook once the author relinquishes actual possession.

A limitation inherent in the use of a paper notebook is the fact that the material contained in the notebook is available to persons who have interest therein only by attaining temporary physical control of the notebook and perusing its contents. This perusal is facilitated if the author indexed the contents, but this has not always been done. Another limitation is that a paper notebook has a fixed number of pre-numbered pages, each of a fixed size. Pages cannot be added or deleted even though large numbers of printed items may be affixed to single pages. Contents that are to be “deleted” are crossed out and the page labeled “VOID”.

Electronic record-keeping systems are known. A protocol for electronic record-keeping that is intended to satisfy evidentiary requirements by requiring that signatures be associated with created records is set forth in Electronics Record Consortium Symposium, Legal Defensibility of Electronic Records—Industry Perspective, Oct. 27, 1995.

An electronic notebook implementation is described in the paper, Department of Energy EMSL's Electronic Laboratory Notebook, IEEE Proceedings of IEEE Fifth Workshop on Enabling Technology: Infrastructure for Collaborative Enterprises, Jun. 19-21, 1996.

A system that utilizes third party authentication of a record's origin is exemplified by U.S. Pat. No. Re. 34,954 (Haber et al.), which describes a method for time-stamping of electronic documents. U.S. Pat. No. 5,748,738 (Bisbee et al.) describes a system and method for digital signing, remote authentication and storage of documents.

In view of the foregoing it is believed particularly advantageous to provided a computer-implemented collaborative record-keeping system and method that facilitates the signing of records created by an author, date/time-stamping of that signature from a clock remote from and inaccessible to the author, witnessing of the signed records by a witness designated by the author, and date/time-stamping of the witness signature from a clock remote from and inaccessible to the witness.

### SUMMARY OF THE INVENTION

The present invention is directed toward a computer-implemented system and method for collaborative record-keeping.

The system and method of the present invention includes a server node and at least one user node. The server node has a memory partitioned into a user-accessible section and a repository section. The user-accessible section has at least one personal scratch space affiliated with a user. The personal scratch space contains unsigned records created by that user acting as an author and a copy of signed records by that user acting as an author. The repository section has at least one team library having at least one notebook therein. The notebook is affiliated with a user and contains records that have been signed by that user acting as an author and records that have been signed and witnessed.

The user node is operable in either an author mode or a witness mode. When operable in the author mode the user node is connectible to the personal scratch space of a user for storage of an unsigned record and retrieval of a previously-stored unsigned record for editing and/or signing by that user acting as an author. The signed record includes a signature string derived from a hashed combination of at least a portion of the record, a first date/time stamp provided by the server, and a data string representative of the identity of that user acting as an author. When the user acting as an author has signed a record, the record is stored in a notebook of that user in the team library and a copy of the record is stored in that user's personal scratch space.

When the user node is operable in the witness mode the user node is connectible to the team library for retrieval of a signed record from a notebook therein for review and signing by a user acting as a witness. The witnessed record includes a witness signature string derived from a hashed combination of at least a second date/time stamp provided by the server node and a data string representative of the identity of the user acting as a witness. After the witness has witnessed the signed record the user node is connectible to the team library for storage of the signed and witnessed record in a notebook therein.

### BRIEF DESCRIPTION OF THE DRAWINGS

The invention will be more fully understood from the following detailed description, taken in connection with the accompanying drawings which form a part of this application in which:

FIG. 1 is a stylized diagrammatic representation of a computer-implemented collaborative record-keeping system of the present invention;

FIG. 2 is a flow diagram showing the steps of the collaborative record-keeping method of the present invention; and

FIG. 3 is a diagrammatic representation of a typical record format and a flow diagram showing the steps of creating author and witness signature strings.

### DETAILED DESCRIPTION OF THE INVENTION

Throughout the following detailed description, similar reference numerals refer to similar elements in all the figures of the drawings.

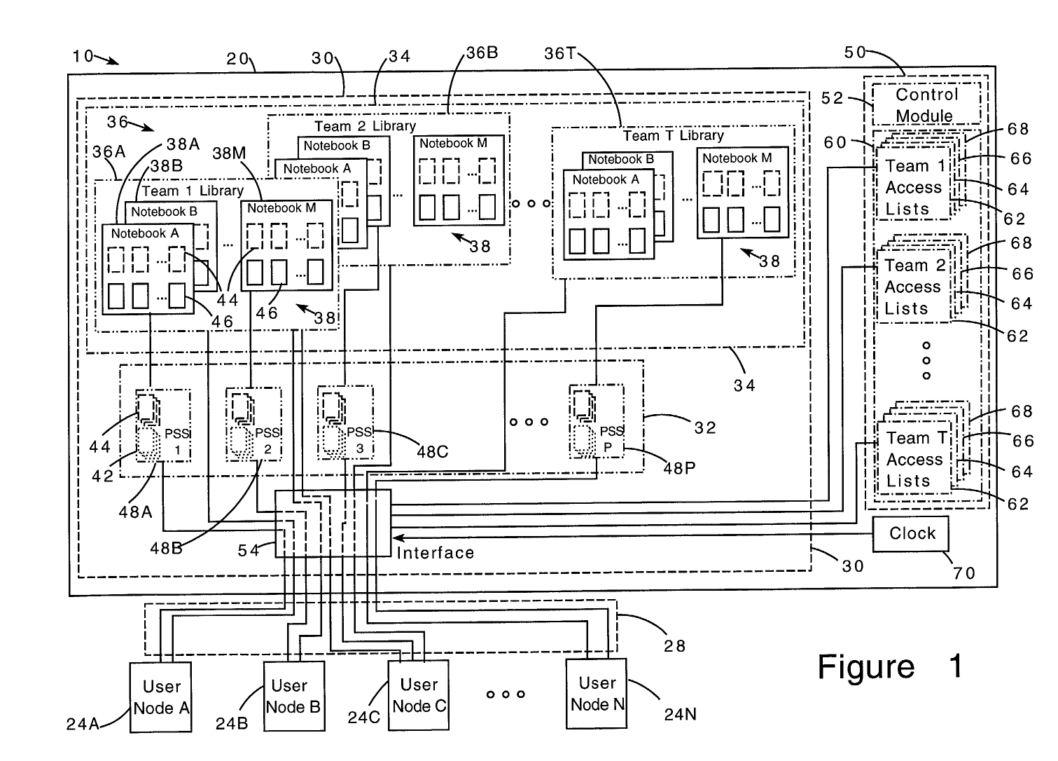

FIG. 1 shows a stylized diagrammatic representation of the architecture of the computer-implemented collaborative record-keeping system 10 of the present invention. The system 10 comprises a server node 20 and at least one, but more preferably, a plurality of user nodes 24A through 24N. As will be described in more detail herein each user node 24 is operable in either an author mode or a witness mode. It should be understood that the term “user node” denotes a hardware location at which an individual user may interact with the system 10. It should be understood that the number N of user nodes is not necessarily the same as the number of individual users of the system.

The server node 20 may be implemented using a pair of enterprise servers such as those sold by Sun Microsystems Inc. under model designation “Ultra Enterprise 450” running under Sun Unix operating system and Lotus Development Corporation server software sold as Notes Domino Server 4.5.7 or later. Each server comprises two four-hundred megahertz (400 MHz) SPARC processors, two gigabytes of random access memory, three internal eighteen gigabyte disc drives, and one gigabit-per-second Ethernet® network connection.

The user nodes 24 are typically implemented using a desktop personal computer, such as a PC-compatible computer running Microsoft Windows® 95 or later, or an Apple MacIntoshe running Mac OS 7 or later. The user nodes run Lotus Development Corporation Lotus Notes® 4.5 or later.

The user nodes 24 are connected to the server node 20 using any standard networking configuration 28, such as an Ethernet® network connection, having Transfer Control Protocol (TCP) with internet protocol (IP), (TCP/IP).

The server node 20 includes a memory 30 that is partitioned to define a user-accessible section 32 and a delete-protected repository section 34. The memory 30 can be implemented using any suitable storage medium, typically a combination of random access semiconductor memory and a magnetic or optical disk memory.

The repository section 34 is partitioned to define at least one, but more preferably, a plurality of team libraries 36A through 36T. Each team library 36 is dedicated to a single collaborative project being undertaken by one or more individual users organized as a team. Each team library 36A through 36T serves as the storage repository for one or more laboratory notebook(s) 38A through 38M. One or more of the laboratory notebook(s) 38 in each team library 36 is(are) assigned to and affiliated with each user forming part of that team, but all team members have read-access to all notebooks within the team library. Project work being generated by each user on that team is recorded in the notebook(s) 38. It should be understood that the number “M” of notebooks 38 stored in each team library 36 may be different. A notebook 38 contains records 44 (shown in dashed outline) that have been signed by the user and/or records 46 (shown in solid outline) that have been both signed by the user and witnessed by an authorized witness.

The user-accessible section 32 of the memory 30 is partitioned to define a plurality of personal scratch spaces 48A through 48P. A personal scratch space 48 is affiliated with each user. As will be developed a personal scratch space 48 of a given user contains unsigned records 42 (shown in dotted outline) created by that user as well as a copy of signed records 44 of that user.

A control program 50 that effects the overall operation of system 10 resides in the server 20. The control program 50 may be implemented in any suitable software application and operating system environment. One software application found suitable to implement the present invention is that available from Lotus Development Corporation and sold under the trademark Lotus Notes®.

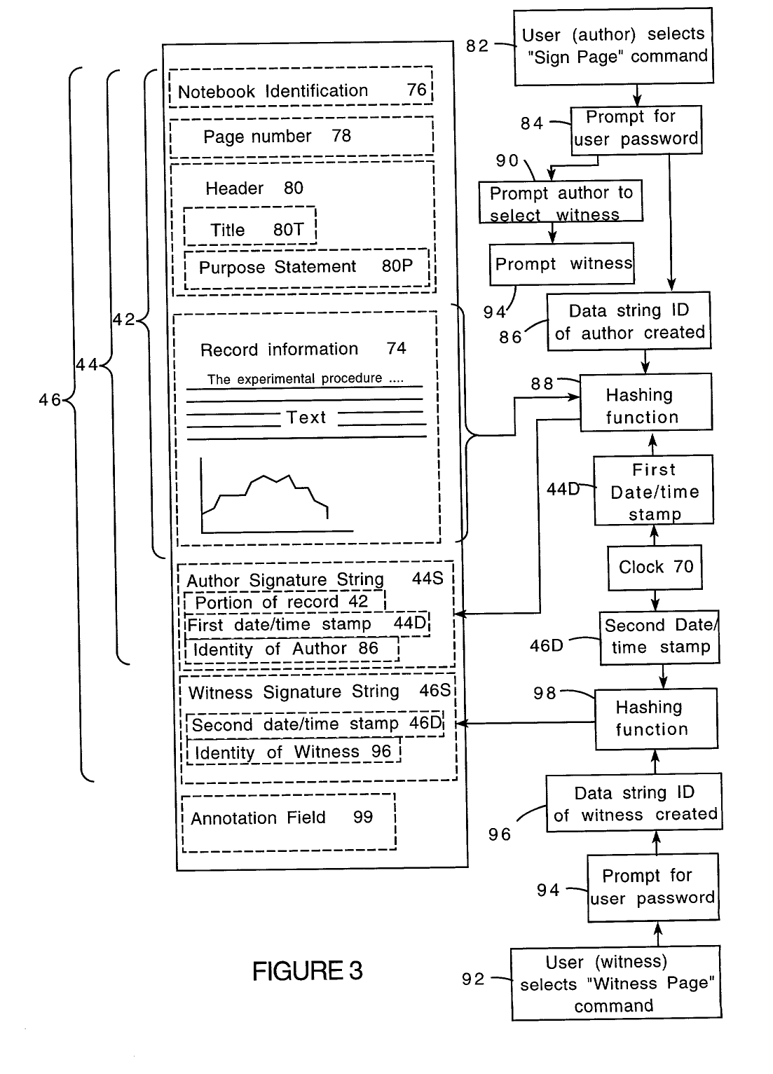

The control program 50 includes a control module 52 that serves to organize the described arrangement of the memory 30, to implement an interface 54 between the server node 20 and the user nodes 24, and to implement functions critical to the operation of the system. As examples of such functions (all of which are to be described) the control program 50 generates a menu of command options available to users, provides user prompts 84 and 94 (FIG. 3), implements hashing functions 88 and 98 (FIG. 3), implements a witness selection prompt 90 (FIG. 3), and notification to a selected witness.

The control program 50 also includes a custodian module 60. The custodian module 60 controls access to the records 42 in the personal scratch spaces 48 and to records 44 and 46 within each team library 36. For each team the custodian 60 creates:

i) an access control list 62 to permit write access by a user acting as an author to unsigned records 42 stored in the personal scratch space 48 of that user, as well as read access by that user to copies of signed records 44 stored in the personal scratch space 48 of that user;

ii) an access control list 64 to permit read access by a user to any signed records 44 or any signed and witnessed records 46 stored in any notebook 38 in a team library 36 for a team of which that user is a member. The access list 64 thus permits a user to read both records 44, 46 created by that user, as well as records 44, 46 stored in the notebooks of any other team member in that team library. In addition, the list 64 may permit other specified users (e.g., supervisory personnel or observers who are not members of a team) to read signed records 44 or signed and witnessed records 46 stored in any notebook in a team library;

iii) an access control list 66 to permit read access by a user acting as a witness to a signed record 44 stored in a notebook in a team library 36; and

iv) an optional access control list 68 to permit read access by a given user to unsigned records 42 stored in the personal scratch space 48 of another user.

The server node 20 also includes a clock 70 from which date/time stamps may be derived. The clock 70 may be accessed by a system administrator, but is inaccessible to a user. As will be explained herein such administrative access does not give rise to the possibility of undetected record alteration.

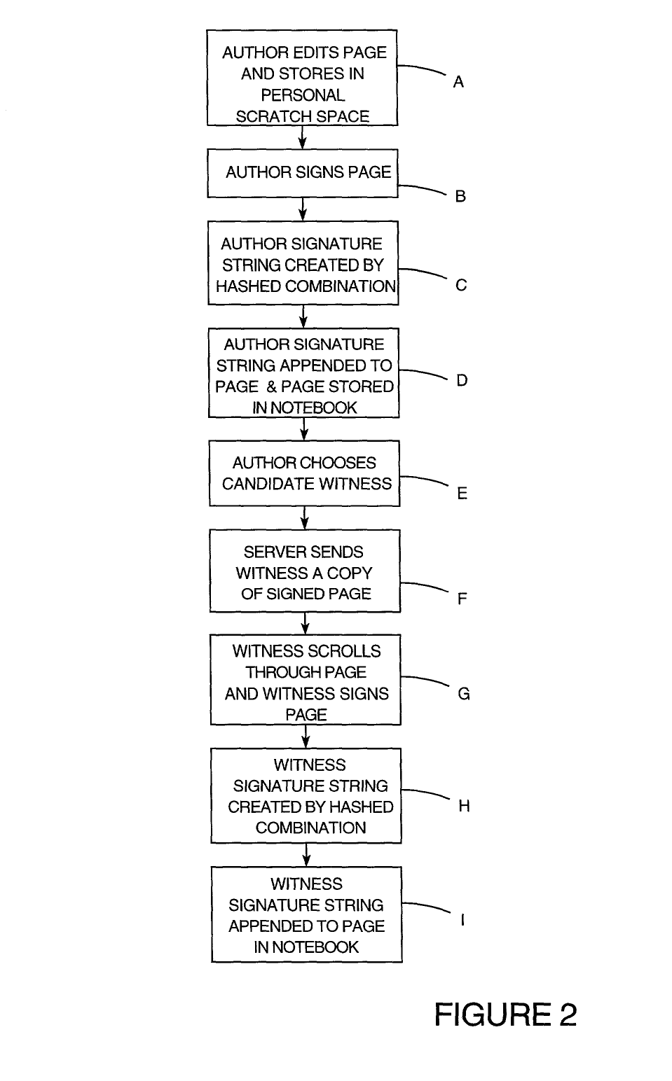

Having described the architecture of the system 10 its use in a collaborative record-keeping environment may now be explained in connection with FIGS. 2 and 3.

When a user desires a new notebook the user generates a request, designates persons to have access to that notebook and submits the request to the custodian 60. The custodian 60 creates a new notebook 38 and sends an electronic link to that notebook to the requesting user by electronic mail.

When a user node 24 is operated in the “author mode”, that is, by a user acting as an author (also referred to as “Content Creator”), the control program 50 in the server 20 connects the node 24 through the interface 54 to the personal scratch space 48 of that user for retrieval of a previously-stored unsigned record 42 for editing and/or signing by that user acting as an author.

The format of an unsigned record 42 is illustrated in FIG. 3. An unsigned record 42 includes, at a minimum, text and data recorded into a field 74 by the user acting as an author. The unsigned record 42 may additionally include a notebook identification 76, a page number 78, and a header 80, typically comprising a title 80T and a purpose statement 80P. The elements of an unsigned record are grouped together in FIG. 3 by the bracket 42.

Specific fields are designated for management and later retrieval of the information recorded. The author's name, the business unit sponsoring and having an “ownership interest” in the research, the research program title, and keywords generated by the author and by information management specialists are examples of such fields.

Retrieval of information of interest is facilitated by providing at least one of the following:

a) a field in the page header of each page for author-generated indexing terms, and for subsequently entered information specialist-generated indexing terms;

b) a searching capability for searching by designated fields or free-text searching all fields within each page;

c) a chemical structure searching capability;

d) links between pages within a notebook and between pages between notebooks;

e) an interactive search engine for searching specified fields, free text, or chemical structures; and/or

f) an interactive category engine, to permit browsing of content by a subject matter classification scheme.

The control program 50 generates a menu of command options available to a user of the system. The command option menu is typically implemented as an icon array on a “toolbar”. The unsigned record 42 may be edited by selecting the appropriate command from the command option menu. The embedded text editor resident in the software application supporting the system 10 may be used to effect the entering and editing of textual information into the field 74. Other forms of electronic data structures such as spread sheets, data plots, digitized images, sound clips, movie clips may also be entered by an author into the field 74 of the unsigned record 42. An edited unsigned record 42 may be re-stored in the personal scratch space 48 (step A, FIG. 2) by selecting another command option.

The author need not designate the notebook to which a page will be assigned until that page is signed, but may designate the notebook assignment before the page is signed. When a page has been assigned to a notebook, whether or not signed, a permanent page identification number is assigned to that page.

Eventually, an unsigned record 42 is retrieved for final editing or signing (Step B. FIG. 2). When a user acting as an author desires to sign a retrieved record 42, the user selects the appropriate command (“Sign Page”) from the command options menu, as indicated at reference character 82 in FIG. 3. The user node 24 is connected by the control program 50 via the interface 54 to both the personal scratch space 48 of that user and the notebook 38 in the team library 36 affiliated with that user. In addition, the user is prompted, (reference character 84, FIG. 3) by the control program 50 to enter a user password. The control program 50 utilizes the user password to generate a data string 86 representative of the identity of the author. The data string 86 may be generated from the user password either directly or indirectly. In a secure network environment the direct use of the password to generate the data string 86 is permissible. In a non-secure network (and even in a secure network) the data string 86 is preferably indirectly generated by the use of the well-known “public key-private key” encryption algorithm (also known as the “RSA algorithm”). The RSA 512-bit algorithm is typically used. This RSA 512-bit algorithm is provided within the earlier-identified software from Lotus Development Corporation.

As indicated at step C, FIG. 2, a one-way hashing function 88 (FIG. 3) within the control program 50 generates a signature string 44S that is the hashed combination of at least the data string 86 representative of the identity of the author, a first date/time stamp 44D provided by the clock 70 in the server node 20 (also known as “Date Signed” stamp), and selected portions of the unsigned record 42. The signature string 44S is a truncated binary output of the hashing function 88. Suitable for use as the one-way hashing function is the well-known MD-2 message digest algorithm also contained within the earlier-identified software from Lotus Development Corporation. Hashing and hashing functions are well-known and a general discussion of the topic is set forth in numerous publications, such as Damgard, I. B., “Collision Free Hash Functions and Public Key Signature Schemes”, Eurocrypt '87: Advances in Cryptology 1987 (published 1988), pp. 203-216.

Portions of the unsigned record 42 that could be included in the hashed combination include the notebook identifier 76, the page identifier 78, the page purpose statement 80P, and portions or the entirety of the data field 74 entered by the author, the title 80T of the page, the name of the author, and/or, the date/time stamp of most recent edit of the data in the field 74 (termed the “page-edit history”).

Upon its generation the signature string 44S is appended to the unsigned record 42 thereby to create a signed record 44. The elements of a signed record 44 are grouped together in FIG. 3 by the bracket 44. The signed record 44 (including the signature string 44S) is stored in the notebook 38 in a write-protected and delete-protected manner (Step D, FIG. 2). By “write-protected” it is meant that someone interacting with the system 10 on the user level is not permitted to make any alteration to the record after it is signed. By “delete-protected” it is meant that neither a user nor a system administrator is able to delete the record.

The user node 24 is also operable in the witness mode. Upon storage of the signed record 44 in the notebook 38 the control program 50 generates a witness selection prompt 90 (FIG. 3) to the user acting as an author. The author is presented with the access list 66 from which the author selects a potential witness (Step E, FIG. 2). An author is not permitted to serve as witness to a page signed by that author.

The selected witness is notified by the control program 50. Upon response to the witness selection notification the node 24 occupied by the user acting as the witness is connected to the team library 38 for retrieval of a signed record 44 from a notebook 38 in the team library 36. A copy of the signed record 44 is transmitted to the user node occupied by a user acting as a witness for review (Step F, FIG. 2). The user acting as a witness is thus permitted read access to a signed record 44 stored in a notebook 38 in a team library 36.

No further activity is permitted by the control program 50 until the user acting as a witness has scrolled through the entire signed record 44 and thereafter selects the appropriate command (“Witness Page”) from the command options menu (Step G, FIG. 2). The “Witness Page” command is typically implemented as a “button” located at the bottom of a signed page. The witness is thus required to scroll to the bottom of the signed page in order to witness the page.

The user acting as a witness is then prompted (reference character 94, FIG. 3) by the control program 50 to enter a user password. The user password is used by the control program 50 to generate a data string 96 representative of the identity of the witness. As previously discussed in connection with the generation of the author signature the data string 96 representative of the identity of the witness may be generated from the user password either directly or indirectly.

As indicated at Step H, FIG. 2, a second one-way hashing function 98 (FIG. 3) within the control program 50 generates a witness signature string 46S. The witness signature string 46S is the hashed combination of the data string 96 representative of the identity of the witness and a second date/time stamp 46D provided by the clock 70 in the server node 20. Optionally, additional components may be included in the hashed combination. For example, a portion of the text and data field 74 in the signed record 44 and/or the author signature string 44S may be included in the hashed combination to form the witness signature string 46S. The signature string 46S is a truncated binary output of the second hashing function 98.

Upon its generation the witness signature string 46S is appended to the signed record 44 thereby to create a signed and witnessed record 46 (Step I, FIG. 2). The elements of the signed and witnessed record 46 are grouped together in FIG. 3 by the bracket 46. The signed and witnessed record 46 (including the signature string 46S) is stored in the notebook 38 in a write-protected and delete-protected manner.

An annotation field 99 containing incidental information may be optionally appended to the signed and witnessed record 46. The annotation field 99 may, for example, contain cross-references to pages in either the same notebook or other notebooks within the team library or to pages in non-electronic records, such as paper notebooks.

As may be appreciated from the foregoing the present invention is directed to a system and method that appends to a record produced by an author signature string that is derived from a hashed combination of at least three components: viz., 1) a part of the record: 2) a first date/time stamp from a server node remote from author; and 3) a data string representative of the author. The system and method also authenticates the signed record using a signature string of a witness that is derived from a hashed combination of at least two components: viz., 1) a second date/time stamp from the server node; and 2) a data string representative of the witness.

Once a record has been signed or signed and witnessed, the truncated binary representations produced by the hashing functions makes detectable any alteration to the record field, the identity of an author or witness, and/or the date/time stamp associated therewith. An alteration may be detected by repeating the hashing to create a hashed combination as a verification author signature string and/or a verification witness signature string. One or both verification signature string(s) may then be compared with the corresponding original signature string. Any disparity between the respective original signature string and the verification signature string reveals an attempt at alteration. This ease of detection of alteration enhances the credibility of a record created and stored in accordance with the present invention.

The system 10 as herein described is believed to provide a viable alternative to traditional laboratory notebooks for recording and storing records. However, it should be appreciated that the utility of the system 10 is not limited to a research and development environment, but has applicability to any endeavor wherein corroborated records (i.e., record signed by an author and witnessed by another individual) are necessary.

The system and method of the present invention thus facilitates collaborative record-keeping of research records. Owing to the client/server implementation the present invention is able to effect specific functions extending beyond those provided by paper notebooks and which facilitate record-keeping efficiencies.

Such specific functions include the ability to assign a new notebook to an author by electronic mail, thus avoiding the physical transfer of a bulky object. An individual user, acting as an author, is able to record information in a “scratch space” affiliated with that user, so that a created electronic record or “page” need not be assigned to a notebook until the author decides it is time to do so. The author controls read access by others of the recorded information that remains in the scratch space.

When the author requests that a page of recorded information be “signed” the author may select the specific notebook in which the page is to be stored. The signed page is then authenticated with a digital signature string derived from a hashed combination of the page contents, a first date/time stamp provided by the server node, and the identity of the author. That signed page is transferred into the notebook selected by the author, where the authenticated page is stored in a write-protected and delete-protected manner. The digital signature string insures that the recorded information cannot subsequently be altered without detection.

Witnessing of a page is accomplished by establishing a link that a candidate witness can follow to access and review the signed page and occurs without the need for the witness to be physically brought together with the notebook. The witnessed page is then authenticated with a digital witness signature string derived from a hashed combination of a second date/time stamp provided by the server node and the identity of the witness. The digital witness signature string insures that the recorded information cannot subsequently be altered without detection.

The contents of a notebook may be perused simultaneously by multiple individuals who have been granted access to a team library in which the notebook resides. Notebook access is restricted to project teams, with notebook authors able to belong to multiple teams, to facilitate both teamwork and security of notebook contents.

Notebooks may be closed, i.e., made inactive, after a project is completed. The closed notebooks are moved to an electronic archive for management by one or more information specialists. Information of interest may be retrieved by electronic searching of the pages within the notebooks to facilitate the long-term accessibility and usability of the notebook contents.

Those skilled in the art, having the benefit of the teachings of the present invention as hereinabove set forth may effect numerous modifications thereto. Any such modifications should be construed as lying within the contemplation of the present invention, as defined by the appended claims.

What is claimed is:

1. A system for collaborative record-keeping comprising:
a server node having a memory therein, the memory having a user-accessible section and a repository section,
the user-accessible section having at least one personal scratch space, the personal scratch space being affiliated with a user and containing unsigned records created by that user acting as an author and a copy of records signed by that user acting as an author;
the repository section having at least one team library having at least one notebook therein, the notebook being affiliated with a user and containing records that have been signed by that user acting as an author and records that have been signed and witnessed, and
at least one user node connectible to the memory of the server, the user node being operable in either an author mode or a witness mode,
when operable in the author mode,
the user node being connectible to the personal scratch space of a user for retrieval of an unsigned record for editing or subsequent signing by that user acting as an author, and
the user node being connectible to both the personal scratch space of a user and a notebook of that user in the team library, for storage of a record signed by that user acting as an author in both the personal scratch space and in the notebook,
wherein the signed record includes an author signature string derived from a hashed combination of at least a portion of the record, a first date/time stamp provided by the server, and a data string representative of the identity of that user acting as an author; and
when operable in the witness mode,
the user node being connectible to the team library
for retrieval of a signed record from a notebook in the team library for review by a user acting as a witness, and,
after reviewing and witnessing the signed record, for storage of a signed and witnessed record in a notebook in the team library,
wherein the signed and witnessed record includes a witness signature string derived from a hashed combination of a second date/time stamp provided by the server node and a data string representative of the identity of a user acting as a witness.

2. The system of claim 1, wherein the signed record is stored in a write-protected manner.

3. The system of claim 1, the server node of the system further comprising
a custodian module maintaining access control lists for allowing:
write access by a user acting as an author to unsigned records stored in the personal scratch space of that user;
read access by a user to signed records stored in the personal scratch space of that user;
read access by a user to signed records stored in any notebook in the team library; and
read access by a user acting as a witness to a signed record stored in a notebook in the team library.

4. The system of claim 3, wherein the custodian module maintains an access control list for allowing read access by a second user to unsigned records stored in the personal scratch space of a first user.

5. A method for signing and authenticating a record using a computer network comprising a server node and at least one user node connected to the server, the method comprising the steps of:
a) at a user node occupied by an author, creating a record;
b) applying a signature string to the created record, the signature string being derived by hashing a combination of at least
a portion of the record,
a date/time stamp provided by the server, and
a data string representative of the identity of the author, thereby to create a signed record;
c) transmitting the signed record from the user node to the server; and
d) thereafter, storing the signed record in a memory in a write-protected manner.

6. The method of claim 5 wherein the memory comprises a repository section and a user-accessible section, and
wherein, in step (d), the signed record is stored in both the repository section and the user-accessible section in a write-protected manner.

7. The method of claim 6 wherein the repository section of the memory is also delete-protected.

8. The method of claim 5, wherein the computer network comprises a plurality of user nodes, the method further comprising the steps of:
e) creating a list of users having authorized read-only access to a signed record;
f) upon request from a user for a copy of a signed record, verifying that the requesting user is authorized; and
g) after verification of the authorization, transmitting a copy of the signed record from the server node to a second user node different from the first user node.

9. The method of claim 5 further comprising the steps of, after step a):
a1) generating a request for a password;
a2) in response to the password request, entering a password representative of the author, the data string representative of the identity of the author being derived from the password.

10. The method of claim 9 further comprising the steps of:
a3) after entry of a password, providing the date/time stamp from the server.

11. A method for signing, witnessing and authenticating a record using a computer network comprising a server node and at least one user node connected to the server, the method comprising the steps of:
a) at a user node occupied by an author, creating a record;
b) applying an author signature string to the created record, the author signature string being derived by hashing a combination of at least
a portion of the record,
a first date/time stamp provided by the server, and
a data string representative of the identity of the author, thereby to create a signed record;
c) transmitting the signed record from the user node to the server;
d) thereafter, storing the signed record in a memory in a write-protected manner;
e) transmitting a copy of the signed record from the server node to a user node for witnessing by a witness;
f) appending to the signed and stored record a witness signature string derived by hashing a combination of
a second date/time stamp provided by the server, and
a data string representative of the identity of the witness; thereby to create a witnessed record.

12. The method of claim 11 wherein, in step (f), the combination which is hashed to derive the witness signature string further includes the author signature string.

13. The method of claim 12 wherein, in step (f), the combination which is hashed to derive the witness signature string further includes a header field comprising a notebook identifier, a page identifier, a purpose statement, and a page-edit history of the page.

14. The method of claim 11 wherein the memory comprises a repository section and a user-accessible section, and
wherein, in step (f), the witnessed record is stored in both the repository section and the user-accessible section in a write-protected manner.

15. The method of claim 11 wherein the repository section of the memory is also delete-protected.

16. The method of claim 11, wherein the computer network comprises a plurality of user nodes, the method further comprising the steps of:
g) creating a list of users having authorized read-only access to a witnessed record;
h) upon request from an authorized user, transmitting a copy of the witnessed record from the server node to a user node occupied by a user having authorized read-only access.

17. The method of claim 11, wherein the appending of a witness signature string is conditioned upon the entire record being scrolled at the user node occupied by the witness.

18. The method of claim 11, wherein step (e) is conditioned upon a request from the author.

19. The method of claim 11, wherein prior to step (e) the author selects a witness from a predetermined list of witnesses maintained at the server, and wherein
in step (e), the signed record is transmitted from the server node to a user node occupied by the selected witness.

20. The method of claim 11 wherein step (e) itself comprises the steps of:
e1) generating a request for a password;
e2) in response to a password request, entering a password representative of the witness, the data string representative of the identity of the witness being derived from the password; and
e3) after entry of a password, providing the second date/time stamp from the server node.

21. The method of claim 5, further comprising the steps of verifying the integrity of the stored record by:
e) retrieving the stored record;
f) creating a verification author signature string by hashing the combination of the same portion of the stored record, the first date/time stamp, and the data string representative of the identity of the author; and
g) comparing the verification author signature string with the author signature string to verify that no alterations have been made to the stored record.

22. The method of claim 11, further comprising the steps of verifying the integrity of the stored record by:
g) retrieving the stored record;
h) creating a verification witness signature string by hashing the combination of the second date/time stamp and the data string representative of the identity of the witness; and
i) comparing the verification witness signature with the witness signature string to verify that no alterations have been made to the stored record.

23. The method of claim 11 further comprising the steps of:
g) storing notebooks in an electronic archive for management by an information specialist;
h) retrieving information of interest by electronic searching of the pages within the notebooks, wherein retrieval is facilitated by at least one of the following:
i) providing a field in the page header of each page for author-generated indexing terms and a field for subsequently entered information specialist-generated indexing terms;
ii) providing a searching capability for searching by designated fields or free-text searching all fields within each page;
iii) providing a chemical structure searching capability;
iv) providing links between pages within a notebook and between pages between notebooks within a team library;
v) providing an interactive search engine for searching specified fields, free text, or chemical structures; and
vi) providing an interactive category engine, to permit browsing of content by a subject matter classification scheme.

24. The method of claim 11, wherein the transmitting step e) itself comprises the steps of:
i) creating a link to the signed record;
ii) transmitting this link to a candidate witness by electronic mail from the server node;
iii) linking the candidate witness to the signed record for review and witnessing by the witness.

25. The method of claim 24, wherein after step e), further comprising the steps of:
g) sending a reminder to the candidate witness at predetermined intervals until the signed record has been witnessed;
h) sending a status message to the author reporting all unwitnessed pages;
i) providing the author the capability to designate at least one alternate candidate witness; and
j) disabling any links to any candidate witness after the signed record has been witnessed.
